(19) United States
(12) Patent Application Publication
(10) Pub. No.: US 2019/0242801 A1
(43) Pub. Date: Aug. 8, 2019

(54) DEVICE AND METHOD FOR CALIBRATION OF VELOCITY AND BREAKING FORCE OF A TABLE TESTING DEVICE

(71) Applicant: ERWEKA GmbH, Langen (DE)

(72) Inventors: Werner Müller, Langen (DE); Levent Bozkurt, Rosbach (DE)

(73) Assignee: ERWEKA GmbH, Langen (DE)

(21) Appl. No.: 16/365,805

(22) Filed: Mar. 27, 2019

(30) Foreign Application Priority Data
Feb. 8, 2018 (EP) 18155871

(51) Int. Cl. G01N 3/62; G01N 3/40

(52) U.S. Cl. CPC G01N 3/62; G01N 2033/0077; G01N 3/40

(57) ABSTRACT

The invention relates to a device for fitting a tablet testing device with a calibration unit. The calibration unit allows of calibrating and adjusting the velocity or breaking force of a breaking jaw of such tablet testing device, for determining the breaking hardness of tablets. The invention allows of calibrating the velocity of movement of the breaking jaw and the breaking hardness applied in timely intervals, as to comply with modern quality control standards for pharmaceutical instruments of measurement. The device is employed for temporarily fitting a tablet testing device for calibration, and is mounted onto the tablet testing device only for the purpose of conducting calibration runs, whilst storing the bulky and huge calibration device separate from the tablet testing device during times of normal operation.

### BACKGROUND OF THE INVENTION

The Invention relates to a device for mounting a tablet testing device with a calibration unit, which unit serves to calibrate and adjust the breaking force of a breaking jaw of a tablet testing device for measuring the breaking force of tablets. By means of said device, the velocity of a breaking jaw and the set hardness of breaking may be calibrated in regular intervals, such as that modern quality control standard for pharmaceutical measuring devices are matched.

The device is used to temporarily fit a tablet testing device for calibration, wherein said device is connected to the tablet testing device for the purpose of calibration. During normal use, the bulky and huge device is separated and stored away from the tablet testing device.

Tablets need to be tested for breaking strength before put into commerce. Typically high-through put tablet testing device are used for that purpose. Such devices comprise a testing chamber, an opposing jaw and a movable breaking jaw which breaking jaw jams the tablet in between the opposing jaw and the breaking jaw. Further said tablet testing devices comprise an actuator unit for actuating the breaking jaw and a measuring device for measuring the velocity of the breaking jaw and the set breaking force. Frequently, said tablet testing devices are used for measuring the dimension of tablets, wherein the breaking jaw of the tablet testing device is not moved onto the tablet up to the point of break but is stopped at a preset maximum force and the distance of movement is determined and used for calculating lenght, width and diameter of a tablet.

Examples of such tablet testing devices are known from the state of the art. Document DE102015114600 B3 describes a device and a method for testing tablets wherein the device comprises a testing chamber, a breaking jaw, an opposing jaw and an abutment that is preferably arranged orthogonally to the opposing jaw, further wherein the device comprises a movable strip of tin fitted for positioning and aligning a tablet for testing, and wherein the longitudinal axis of said tin strip corresponds to its direction of movement and is oriented in an angle less than 90° relative to the longitudinal axis of movement of the breaking jaw, and wherein the tablet is positionable along the abutment by the movement of the tin strip into one direction and along the opposing jaw by movement of the tin strip into the opposite direction.

The testing chamber of tablet testing devices often contains a longitudinal positioning surface into which tablets are given after a thinning step, for individual measurement. To this end, said tablets are thinned out by a thinning device first and are then positioned one-by-one on a measuring surface confined the the breaking jaw and opposing jaw. Subsequently, the breaking jaw is moved onto the opposing jaw, wherein the individual tablet to be assessed is placed in between the breaking and the opposing jaw and is finally jammed in between these. The closing-in movement takes places at slow speed, in order to have the tablet affixed in the desired position. After jamming, the breaking forces is risen up to the point of breaking. Often the dimension of a tablet is determined along with the breaking strength by stopping the breaking jaw at a preset breaking force, prior to breaking the tablet.

The measurement of dimension and breaking strength of the tablet follows standardized and precisely prescribed methodological steps. Measurements are standardized and documented in the textbooks for the art. An example of such is the German ‘Deutsches Arzneibuch’. Another example which comprises descriptions of the dimensional and breaking strength measurement and testing for tablets, is the american ‘United States Pharmacopeial Convention’, edition USP 40 of Dec. 1, 2017, chap. 1217 ‘General Information’, pages 1750 to 1752, wordwide web:

http://app.uspnf.com/uspnf/pub/index?usp=40&nf=35&s=2&officialOn=December%201,%202017

In there, it is described that calibration of devices of measurement is imperative, otherwise measurements of tablets are not reproducible. The increase in breaking force has to take place at constant rate, as a sudden increase in compressing force will provoke random decomposition of the tablet and breaking by shearing forces instead. In particular the velocity of moving the breaking jaw onto the tablet and the breaking force necessitated for reproducible breaking of the tablet have to be calibrated.

Commercially available tablet testing devices that are in use at customer's facilities, hence need to calibrated in regular intervals for obtaining reliable results. Typical calibration intervals are annual periods, for instance.

Hitherto calibration is carried out according to the state of the art with tools that have always to be collected piecemeal once a new calibration run is scheduled. This is laborious and costly in time for preparation. Therefore it would be a big advantage to have a readily mounted device available in case of need, by means of which a tablet testing device can be made ready for calibration by simply mounting a or connecting to a calibration device. A permanent unit for making a tablet testing device fit for calibration is usually not desirable; this because commercial tablet testing devices of manageable size and can be easily transported. A permanent calibration unit built in to the tablet testing device would increase space consumption of existing tablet testing devices in quite an undesirable extend.

### SUMMARY OF THE INVENTION

Accordingly there is the problem of making available a device which allows of equipping a tablet testing device in a simple way for a single calibration run within a given calibration interval. The present invention solves this problem by means of a calibration device which contains a measuring device, a computer unit, a communication interface to the tablet testing device, and means of connection between the measuring device, the computer unit and the communication interface.

By connecting said calibration device with the tablet testing device, the tablet testing devicemay be prepared quickly and easily for calibration. A tablet testing device may be equipped easily, and without loss of time, with a device for calibration, the latter which is only used during the calibration round within the scheduled calibration interval. During normal operation, the bulky and spacious calibration device is kept and stored separate from the tablet testing device. Further, additional sources of error are avoided due to the instant tablet testing device because calibration is carried out by means of the readily assembled calibration device.

The computer unit contains a computer comprising the data necessary for calibration, based on which calibration is carried out. Said data were fed into the computer by programming, for instance. Operational control of the measuring device and the computer unit, during a calibration run, is via the display unit and the data entering unit of the tablet testing device. By means of the device of the instant invention, modern quality control standards for pharmaceutical measuring devices can be easily obeyed to.

Typically, the calibration device is used to calibrate the velocity by which the breaking jaw is moved onto the tablet, or the breaking force required for breaking a tablet. According to the present invention, is equally possible to calibrate only the velocity of the breaking jaw or the breaking force required for breaking a tablet.

In particular a device is provided for calibrating a tablet testing device, which calibration device is a measuring system for velocity or breaking force of a breaking jaw, comprising

at least one measuring device for measuring velocity or breaking force of a breaking jaw of a tablet testing device,

a computer unit for reading and evaluating data obtained during measurement, and characterized in that

the calibration device comprises a communication interface to a tablet testing device, the testing device comprising a display unit and a data entering unit, and

connection means between the one or several measuring devices, the computer unit and the communication interface, such as that

the calibration unit may be connected to the tablet testing device via the communication interface, whereby the data obtained by the measuring device can be transmitted via by communication interface to the tablet testing device, thus making said data visible on said display unit and processable by said data entering unit, and

wherein the computer unit may be used for evaluating the data obtained by measuring velocity and breaking force, whereby the actuator of the breaking jaw of the tablet testing device may be controlled and calibrated.

In one embodiment of the invention, the measuring device is a distance measurement unit, or a load cell or both. The distance measurement unit can be an optical measuring unit, for instance. An optical measuring unit can be a laser-guided measuring device in return. Further optical measuring units and load cells for determining the force applied at breaking hardness are exemplarily described in patent application WO 201103581 A1. A distance measurement unit, in a simple embodiment, can be a series of electric contacts which serve to measure the distance of travel of an object moving along. The electric contacts are arranged in a staggered manner and their number corresponds to the distance units traveled. For measuring the distance of travel, the contacts are triggered subsequently by the breaking jaw whilst travelling a distance by a counter contact, which allows of measuring the distance of travel.

In another embodiment of the invention, the communication interface to a tablet testing device is a USB plug-in connection. Thereby the device is connected to the tablet testing device. By means of a USB plug-in part, as is routine and is commonly used in computer hardware, a fast and standardized communication line between the device and the tablet testing device is feasible. Other means of communication such as wireless data communication devices may be used as well.

The receiving port for the USB plug-in connection may be placed at the tablet testing device at any site, preferably is connected to the display unit of the tablet testing device. It goes without saying that the computer unit of the calibration device of the present invention is compatible with the computer of the tablet testing device.

In another embodiment of the present invention the connection means between the one or several measuring devices, the computer unit and the communication interface are electric wires.

The computer unit preferably is a computer unit which autonomously evaluates data on velocity and breaking force obtained by measurement and is transmitting them to the display unit and the data entering unit of the tablet testing device. Computer units for calibration of tablet testing devices are known from the state of the art, likewise computer software for operating such computer units.

In case the device according to the present invention comprises several measuring devices and the tablet testing device comprises already calculation software for calibration, then in a simple embodiment the computer unit may be a junction box which forwards the data obtained by measurement of velocity or breaking force to the computer of the tablet testing device.

In an embodiment of the invention, calibration of velocity or breaking force of a breaking jaw of the tablet testing device is feasible. In the former case, the devices contains a distance measuring unit and in the latter case a load cell. In a preferred embodiment of the invention the device of the present invention allows of calibrating velocity and breaking force. Accordingly the device comprises a distance measurement unit and a load cell. Therein the computer unit is fitted as to calibrate either the breaking force or both the velocity and the breaking force. Correspondingly the computer unit then comprises suitable software.

With the device according to the present invention, it is feasible to store or record data obtained for velocity or breaking force or both, additionally or alternatively to performing calibration. In that case the computer unit comprises software for storage or recordation.

In an embodiment of the invention the device for calibration is mountable or screwable. This way it may be installed onto the tablet testing device easily and with little delay. In particular the measuring device for velocity and breaking force may be installed with ease. The joining by screwing of said measuring devices onto the tablet testing device can be done by screws, for instance. The mounting of said measuring devices onto the tablet testing device can be done by pin connectors, for instance.

It is further an aspect of the invention to provide a method for calibrating a tablet testing device by means of which a tablet testing device is calibrated with the presently described device. By means of the instant method the device described above for calibrating is connected with a tablet testing device, the velocity and breaking force of a breaking jaw is calibrated, and the device for calibrating is removed again.

In particular a method is provided for calibrating the velocity and breaking force of a breaking jaw of a tablet testing device, wherein

in a tablet testing device, a tablet intended to be measured is inserted into a testing chamber, between a breaking jaw and an opposing jaw of the tablet testing device,

the breaking jaw is moved towards the opposing jaw of the tablet testing device at a given velocity, and wherein the method is characterized in that

the tablet testing device is connected to a device for calibration as is described above, which testing device comprises at least one measuring device for measuring the velocity or breaking force of a breaking jaw, a computer unit, a communication interface, and means of connection between the one or several measuring devices, the computer unit and the communication interface,

wherein during measurement, the distance of travel per time unit or the breaking force is measured, thereby measuring the velocity or breaking force of the breaking jaw and calibrating it versus the values stored, and

wherein the tablet testing device is disconnected from the calibration device after the calibration run again.

Breaking force in the present context means the force required to bread a tablet. In a preferred embodiment of the method of the invention, both the breaking force as well as the velocity of the breaking jaw is measured and calibrated versus the values stored.

In a further embodiment of the present invention the calibration is conducted versus benchmarked calibration values pre-stored in the computer unit. To this end the computer unit was programmed with suitable reference values for calibration. In the context of the present invention to perform the calibration based on data which are comprised in the computer unit of the tablet testing device. In that case, the above described device serves to mount but the measuring devices onto the tablet testing device which measuring devices are then connected via the junction box and the connection means further via the communication interface to the tablet testing device. Further it is possible in the context of the present invention that the benchmarked calibration values, versus which calibration is conducted, are stored on an external computer. Said external computer may be a pc, for instance. Accordingly the device of the instant invention may be connected to the PC and the tablet testing device in any possible way, for conducting calibration. For example, the device for calibration may be connected via USB plug-in parts as communication interfaces with a PC which has stored the benchmarked calibration values, and with the computer of a tablet testing device that is usually used for conducting measurements, for the purpose of calibration whilst the measuring devices of the calibration device are mounted on the tablet testing device.

In one embodiment of the method the velocity of the breaking jaw is adjusted at a value of from 0.1 mm/second to 3.0 mm/second by calibrating. This value has proven very beneficial when measuring tablets.

When calibrating the tablet testing device of the tablet testing device of the instant invention, in an embodiment of the method a measurement for linearity deviation is conducted during the calibration run. Such measurement is often conducted during calibration of a tablet testing device and exemplarily described in the document ‘The United States Pharmacopeial Convention’, edition USP 40 of Dec. 1, 2017, Chap. 1217 ‘General Information’, pages 1750 to 1752, worldwide web:

http://app.uspnf.com/uspnf/pub/index?usp=40&nf=35&s=2&officialOn=December%201,%202017

The measurement for linearity deviation is carried out in that along the distance of travel of the breaking jaw a measurement of up to three spots in a line is made.

The device for calibrating tablet testing devices is mounted or screwed on the tablet testing device during calibration. To this end, the device for calibrating tablet testing devices comprises screw or pin connections.

Further in typical and preferred embodiment, a calibration of the tablet testing device is done by means the device described above. Alternatively, it is still feasible within the context of the present invention, to have stored or recorded only the data thus obtained. Said data may be evaluated and presented graphically later, e.g. on a monitor.

It is further claimed a method for measuring tablets, which makes use of one of the above described devices. It is claimed in particular a method for measuring tablets which is characterized in that one of the above described devices is employed. By means of a tablet testing devices thus calibrated, the breaking hardness of tablets is determined in particular.

Within the context of the method of the present invention and as a further advantage, it is possible to determine the dimensions of the tablet after calibration of the velocity and breaking force of the breaking jaw. This because for determining for determining the dimensions of the tablet, the breaking jaw must be moved at a pre-set speed and with a pre-set breaking force onto the tablet. As regards the dimensions of a tablet, that may be e.g. length, width or the radius of a tablet.

For determining the dimensions, the breaking jaw is moved onto the tablet at a pre-set and precisely calibrated velocity. Shortly before making contact with the tablet, the speed of movement of the breaking jaw is reduced. The breaking jaw is moved at a lowered speed onto the tablet until reaching a predetermined and calibrated breaking force and jamming the tablet without breaking it. Thereby the dimensions of the tablet are determined. After determining the dimensions of the tablet, the breaking force is subsequently carefully increased, until the tablet is breaking. Concomitantly, the breaking force is measured. For such measurement, regular and precise calibration of the velocity and breaking forces of a breaking jaw of a tablet testing device is essential. The calibration of velocity and breaking force of a tablet testing device are well manageable by the method of the instant invention.

The invention has the advantage of devising a simple and reliable device that can be transported and by means of which a calibration of the velocity or breaking force of the breaking jaw in a tablet testing device is possible in no time. This way a calibration can be conducted in a time saving and simple manner, avoiding sources of error.

### BRIEF DESCRIPTION OF THE DRAWINGS

The invention is illustrated by four drawings wherein it is understood that the drawings are representing embodiments but are not limiting to the invention.

FIG. 1 shows a device according to the present invention, which allows of retrofitting current tablet testing devices.

FIG. 2 shows the testing chamber of a tablet testing device which is equipped with the device according to the present invention, from an inclined perspective from above.

FIG. 3 shows the testing chamber of a tablet testing device which is equipped with the instant device, from lateral view.

FIG. 4 shows a device according to the present invention which is fitted for being mounted onto a tablet testing device by pin connectors.

### DETAILED DESCRIPTION

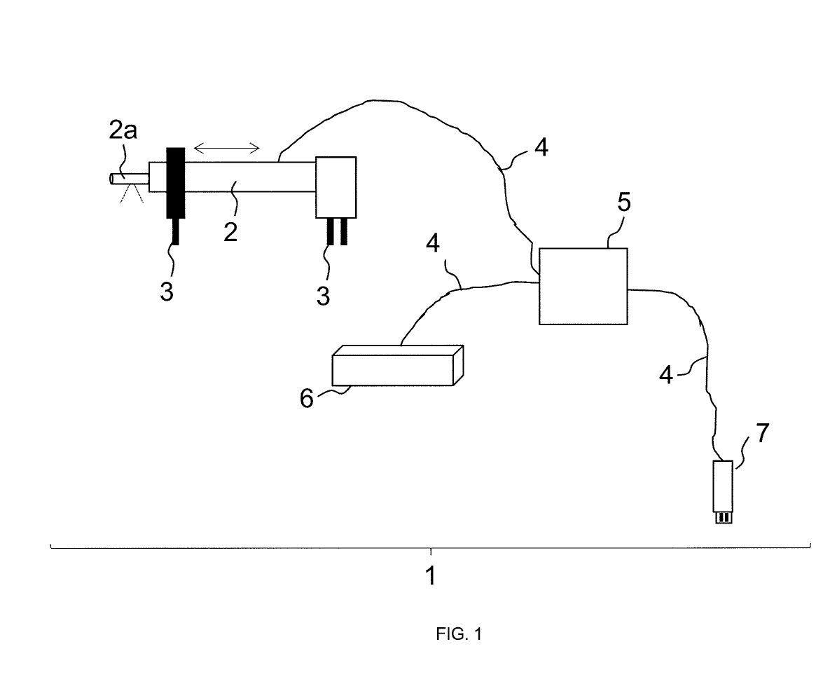

In FIG. 1 a mobile device (1) according to the present invention for calibration tablet testing devices is shown detached from a tablet testing device. It comprises a distance measurement unit (2), which is fitted with pin connectors (3), wherein the distance measurement unit (2) is connected via a wire as connection means (4) with a computer unit (5), further with a load cell (6) which is likewise connected via a wire as connection means (4) to the computer unit (5), and a USB plug-in part as communication interface (7) which is connected via a wire (4) to the computer unit (5), too. Via the USB plug-in part (7) the device (1) may be connected to the tablet testing device (8). Via the pin connector (3) the distance measurement unit may be mounted onto the tablet testing device (8). Here the distance measurement unit (2) is equipped with a laser-guided measuring device (2a) for measuring the distance of travel.

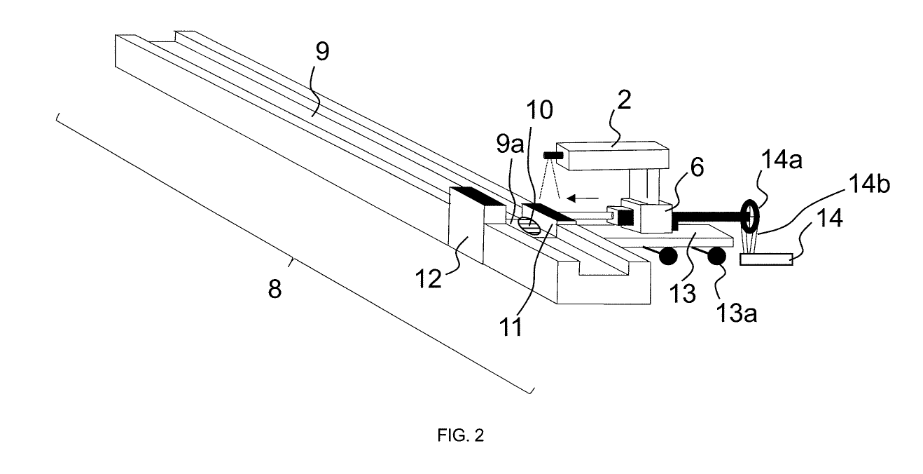

In FIG. 2 it is shown the testing chamber (9a) of a tablet testing device (8), which may be calibrated with the device (1) according to the present invention. The testing chamber (9a) is formed by a positioning surface (9) into which an individual tablet (10) is guided after thinning. The tablet (10) is aligned by a positioning device (not shown) in the testing chamber (9a) as to rest between breaking jaw (11) and opposing jaw (12). After that, the breaking jaw (119 is moving into direction of the arrow onto the opposing jaw (12) until the tablet (19) is jammed between the breaking (11) and the opposing jaw (12). The distance of travel passed by the breaking jaw (11) is determined with an optical device als distance measurement unit (2). By the residual distance to the opposing jaw (12) one dimension, e.g. in case of an oblong tablet (10) the width, may be determined. After jamming and measuring one or several dimensions of the tablet (10), the breaking force is increased up to the point that the tablet (10) finally breaks. The force applied therein is measured by a load cell (6). The breaking jaw (11) resides on a sledge (13) which can be moved into direction of the testing chamber (9a) by a rotating device (13a). The sledge (13) is propelled by an actuator (14). The latter resides at the backside of the sledge (13) and propels the sledge (13) via a belt-driven spindle (14a) and a belt (14b) wherein the sledge (13) is moved along with the breaking jaw (11) onto the opposing jaw (12) or away from it.

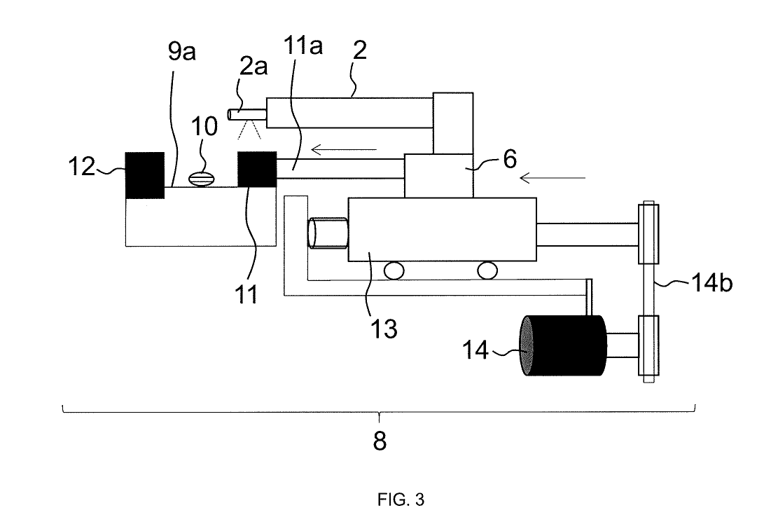

In FIG. 3 it is shown the tablet testing device (8) in a lateral perspective. It is shown first the testing chamber (9a), the breaking jaw (11) and the opposing jaw (12) wherein the breaking jaw (11) is connected via a connector (11a) with a load cell (6). The load cell (6) resides on a sledge (13) which is propelled by a motor als actuator (14) by means of a belt (14b). The sledge (13) is movable in direction of the arrow. Between the breaking jaw (11) and the opposing jaw (12) a tablet (10) is positioned. Upon moving the sledge (13) into direction of the arrow, the breaking jaw (11) is moved into direction of the opposing jaw (12). The movement is continued up to the point that the tablet (10) is jammed in between the breaking (11) and the opposing jaw (12). The breaking force is only raised to a point at which the tablet (10) does not break. Exemplarily, the dimensions of the tablet (10) are determined by the distance of travel. The passed distance is determined optically by an optical distance measurement unit (2). As an example, hee it is used a laser-guided distance measurement device (2a). From the distance of travel passed per time unit, the velocity is determined. The latter is stored and used for calculating an optimal value for the velocity. This optimal value is used then with all subsequent measurement runs on tablets as the benchmark for calibration.

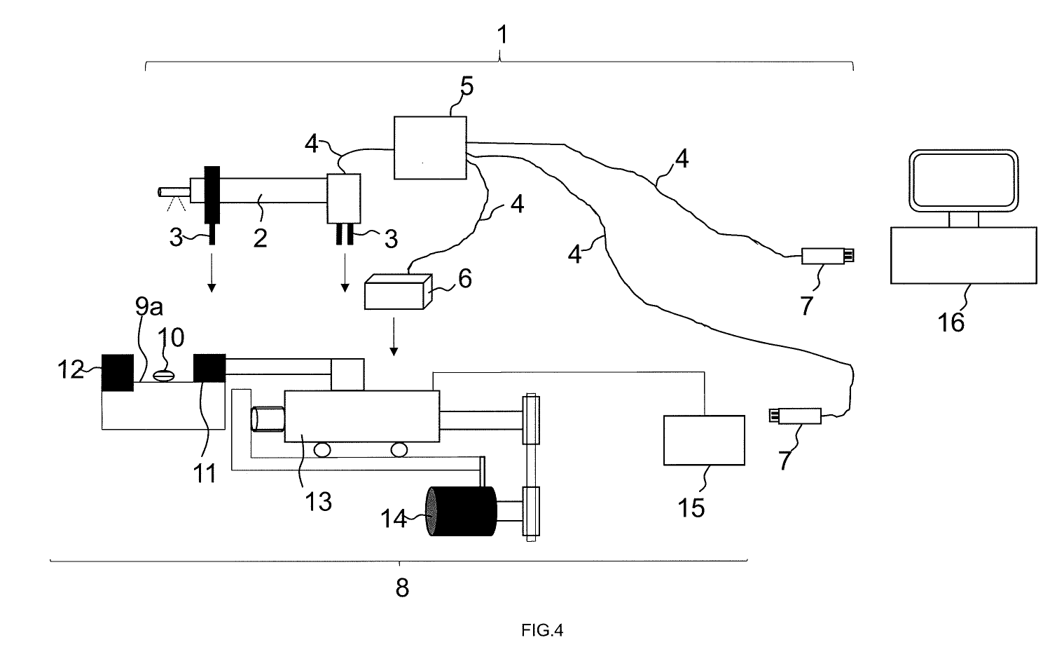

In FIG. 4, a device for calibration according to the present invention (1) is mounted on a tablet testing device (8) into direction of the arrow. Shown is the device (1) of the distance measurement unit (2), the computer unit (5), the load cell (6), the connecting means (4) and the communication interfaces (7). Further shown is the tablet testing device (8), the testing chamber (9a), a tablet (10) in the testing chamber (9a), the breaking jaw (11), the opposing jaw (12), the sledge (13) and actuator unit for the sledge (14). The tablet testing device (8) is further equipped with a computer unit (15) for measurement. What is shown is a PC as an external computer (16) which has stored the reference values as calibration values.

For calibration a device (1) is mounted in direction of the arrow onto the tablet testing device. The device (1) is then connected via a communication interface (7), an USB plug-in part for instance, with the computer (15) of the tablet testing device (8) and the PC of the external computer (16). By means of that, calibration versus the stored benchmarked calibration values may be performed. After calibration, the device (1) for calibration is disconnected again from the tablet testing device (8), the computer of the tablet testing device (15) and the PC as an external computer (16).

What is claimed is:

1. Device for calibrating a tablet testing device which is a measuring system for velocity and breaking force of a breaking jaw in a tablet testing device, comprising
at least one measuring device for measuring velocity and breaking force of a breaking jaw of said tablet testing device;
a computer unit for reading and evaluating the data from measurement
Characterized in that
said computer unit comprises a communication interface to a tablet testing device the latter of which comprises a display unit and a data entering unit, and
connections means between the one or several measuring devices, the computer unit and the communication interface, such as that
the device can be connected via the communication interface with the tablet testing device, and wherein the data obtained from the measuring units can be transmitted to the tablet testing device via the communication interface, and whereby these data can be made visible on the display unit and can be processed via the data entering unit of the tablet testing device, and
the computer unit can be employed for evaluating the data obtained by measuring velocity and breaking force and whereby the actuator of the breaking force of the tablet testing device can be controlled and calibrated.

2. Device according to claim 1, characterized in that at least one of said at least one measuring device is at least one of a distance measuring unit and a load cell.

3. Device according to claim 2, characterized in that the distance measuring unit is selected from the group of an optical measuring device and a laser-guided measuring device.

4. Device according to claim 2, characterized in that the distance measuring unit is a series of electric contacts which serve to measure the distance of travel of the breaking jaw.

5. Device according to claim 1, characterized in that the communication interface to a tablet testing device is USB plug-in connection.

6. Device according to claim 1, characterized in that the connection means between the one or several measuring devices, the computer unit and the communication interface are electric wires.

7. Device according to claim 1, characterized in that the computer unit is a computer that evaluates the data obtained by measuring velocity and breaking force autonomously and transmits them to the display unit and the data entering unit of the tablet testing device.

8. Device according to claim 1, characterized in that the computer unit is a junction box which transmits the data obtained from measuring velocity and breaking force to the computer of the tablet testing device.

9. Device according to claim 1, characterized in that said device allows of calibrating velocity or breaking force or both.

10. Device according to claim 1, characterized in that the device allows for at least one of recording velocity and breaking force.

11. Device according to claim 1, characterized in that that the device can be mounted onto a tablet testing device for the purpose of calibration.

12. Method of calibrating the velocity or breaking force of a breaking jaw of a tablet testing device, wherein
in a tablet testing device an individual tablet to be measured is placed in a testing chamber between an opposing jaw and a breaking jaw of the tablet testing device,
the breaking jaw is moved at a preset speed onto the opposing jaw of the tablet testing device,
characterized in that
the tablet testing device is connected to a calibration device which comprises at least a measuring unit for measuring velocity or breaking force of a breaking jaw, a computer unit, a communication interface, a connection means between the one or several measuring units, the computer unit and the communication interface,
measuring the distance of travel of the breaking jaw per time unit or the breaking force and whereby the velocity or the breaking force of the breaking jaw is determined and is calibrated versus prestored values, and
the tablet testing device is disconnected again from the calibration device after calibration.

13. Method according to claim 12, characterized in that the method for breaking force and velocity of the breaking jaw is measured and calibrated versus prestored values.

14. Method according to claim 12, characterized in that the calibration is conducted versus benchmarked calibration values that are stored in the computer unit.

15. Method according to claim 12, characterized in that the calibration values versus which one does calibrate are stored on an external computer and the calibration device is connected with the external computer and the with the computer of the tablet testing device, for conducting a calibration.

16. Method according to claim 12, characterized in that the velocity of the breaking jaw is adjusted at a value of from 0.1 mm/sec to 3.0 mm/sec by calibrating.

17. Method according to claim 12, characterized in that that when calibrating, a measurement for linearity deviation is done by measuring within the distance of travel of the breaking jaw up to three points in a line.

18. Method according to claim 12, characterized in that the device is mounted onto the tablet testing device during calibration.

19. Method for measuring tablets, comprising the step of using a tablet testing device calibrated by means of a device for calibrating a tablet testing device which is a measuring system for velocity and breaking force of a breaking jaw in a tablet testing device, comprising
at least one measuring device for measuring velocity and breaking force of a breaking jaw of said tablet testing device;
a computer unit for reading and evaluating the data from measurement
Characterized in that
the computer unit comprises a communication interface to a tablet testing device the latter of which comprises a display unit and a data entering unit, and
connection means between the one or several measuring devices, the computer unit and the communication interface, such as that
the device can be connected via the communication interface with the tablet testing device, and wherein the data obtained from the measuring units can be transmitted to the tablet testing device via the communication interface, and whereby these data can be made visible on the display unit and can be processed via the data entering unit of the tablet testing device, and
the computer unit can be employed for evaluating the data obtained by measuring velocity and breaking force and whereby the actuator of the breaking force of the tablet testing device can be controlled and calibrated.

20. Method according to claim 19, characterized in that after calibrating the velocity and the breaking force of the breaking jaw, further the dimensions of the tablet are determined.
